(19) United States
(12) Patent Application Publication
(10) Pub. No.: US 2010/0149141 A1
(43) Pub. Date: Jun. 17, 2010

(54) WIRING OF A DISPLAY

(75) Inventor: Ock-Jin KIM, Hwaseong-si (KR)

Correspondence Address: CANTOR COLBURN, LLP, 20 Church Street, 22nd Floor, Hartford, CT, 06103, US

(73) Assignee: Samsung Electronics Co., Ltd, Suwon-si (KR)

(21) Appl. No.: 12/337,260

(22) Filed: Dec. 17, 2008

(51) Int. Cl. G06F 3/038

(52) U.S. Cl. 345/205

(57) ABSTRACT

A display device includes more than one IC chip formed on a substrate. Analog signals are applied to the ICs with a point-to-point structure. Digital signals are applied to the ICs with a cascade structure. Wirings applying digital signals are widened in the areas having room available so that electrical resistance can be reduced. Wirings in areas not having enough room to widen are applied with multi path technology to reduce electrical resistance. Multi contact technology may be applied to contact the ICs to a glass substrate.

### BACKGROUND

1. Field of Invention

The present disclosure of invention relates to circuitry of a display such as a Liquid Crystal Display (LCD), an Organic Light Emitting Diode (OLED) display, a Plasma Display Panel (PDP), and so on. More particularly, the present invention discloses circuitary that improves the quality of displays.

2. Description of Related Art

Generally, a liquid crystal display (LCD) device includes a display panel that displays an image by transmitting light through a liquid crystal material and through a transparent substrate. The panel includes a liquid crystal (LC) cell, a back light unit (BLU), and circuitry for driving the LC cell and the BLU. The circuitry includes a gate driving circuit, a data driving circuit, a timing control circuit, and some others. The LC cell may include an array substrate and an opposing substrate opposite the array substrate. The LC cell also includes an LC layer between the array substrate and the opposing substrate. The array substrate includes a thin film transistor (TFT) array. The array substrate also includes a plurality of data lines, a plurality of gate lines, and a plurality of pixel electrodes. The LC cell includes an active area and a pheripheral area. The active area is the portion where an image is displayed and the pheripheral area is the portion that surrounds the active area. The pheripheral area may include the gate driving circuit and the data driving circuit.

Recently, there is a demand in the LCD market for a narrower bezel and thinner panel. In response, LCD makers adopted a chip-on-glass (COG) method. In the COG method, an Integrated Circuit (IC) chip is mounted on a substrate of the LC cell. A gate driving IC, a data driving IC, and/or a timing control IC may be mounted on the substrate. The substrate may be made of glass or plastic and may be transparent.

### SUMMARY

The present disclosure is of an invention that provides a means for enhancing the image quality and reliability of a panel by reducing electric resistance and the differences in resistances among areas of the display panel.

In one embodiment, a display device includes a first source IC which is electrically coupled to a control board with a first digital power circuit and a first analog power circuit, a second source IC which is electrically coupled to the first source IC with a second digital power circuit, and a second analog power circuit which couples the second source IC to the control board, wherein the second analog power circuit is not coupled directly to the first source IC.

The first and second analog power circuits may transmit the source voltage of a gray scale. The first and second analog power circuits may transmit the source voltage of a common voltage. The first and second digital power circuit may transmit the source voltages of a logic circuit. The source voltages of a logic circuit may be a gate-on voltage or a gate-off voltage. The first and second source ICs may be mounted on a glass substrate.

In another embodiment, a display device includes a first IC mounted on a glass substrate, a first group of bumps and a second group of bumps formed on the first IC, wherein the first group of bumps and the second group of bumps contact the glass substrate, the bumps of the first group are separated within a first distance of each other, the bumps of the first group are separated from the bumps of the second with a second distance, the first distance is smaller than the second distance, the bumps of the first group are electrically coupled to each other through the IC with conductive material and through a first wire on the glass substrate, and the first group of bumps are elecally coupled to the second group of bumps through the first IC with conductive material and through a second wire on the glass substrate.

The first group of bumps may be positioned on the first IC substantially opposite the second group of bumps in the longitudinal direction. The display may further include a third wire formed on the glass substrate, being electrically coupled to the first wire and the second wire, and extending to an edge portion of the glass substrated to couple to a forth wire outside the glass substrate. At least a portion of the first wire and the second wire may be substantially narrower than most part of the third wire. The display may further include a second IC formed on the glass substrate and electrically coupled to the third wire, wherein the second IC is between the first IC and the edge portion which the third wire extends, and one end of the first wire is connected to the second wire and the other end of the first wire terminates. The latter end of the first wire may overlap with the first IC. The latter end of the first wire may extend outside the overlapping area with the first IC.

Accordingly, with a the display substrate and display device having such a display substrate, a noise in image may be easily removed in the display device, so that display quality of the display device may be enhanced.

### BRIEF DESCRIPTION OF THE DRAWINGS

The above and other advantages of the present disclosure of invention will become clearer by reference to the following detailed description when considered in conjunction with the accompanying drawings wherein:

FIG. 1 is a plan view illustrating a display device according to an exemplary embodiment;

FIG. 2 is an enlarged plan view illustrating a dotted rectangular portion 500 of FIG. 1;

FIG. 3 shows the bottom view of an IC chip which shows the arrangement of the bumps of the IC chip in FIG. 1 and FIG. 2;

FIG. 4 is an enlarged view of a dotted rectangular portion 460 illustrated in FIG. 3;

FIG. 5 is an enlarged view of a dotted rectangular portion 470 illustrated in FIG. 3;

FIG. 6 is a cross-sectional view of an area where an IC is mounted.

### DETAILED DESCRIPTION

It is to be understood that when an element or layer is referred to herein as being “on,” “connected to” or “coupled to” another element or layer, it can be either directly on, connected to or coupled to the other element or layer, or one or more intervening elements or layers may be present for providing indirect coupling. In contrast, when an element is referred to herein as being “directly on,” “directly connected to” or “directly coupled to” the other element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited in number by these terms. These terms are only used to distinguish one element, component, region, layer or section from another region, layer or section. Thus, a first element, component, region, layer or section discussed below could be instead termed a second element, component, region, layer or section.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above.” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present disclosure of invention.

Embodiments described herein with reference to cross-section illustrations are to be considered as schematic illustrations of idealized embodiments (and intermediate structures). As such, variations from the shapes of the illustrations as a result, for example, of specific manufacturing techniques and/or tolerances, are to be expected. Thus, the disclosure should not be construed as being limited to the particular shapes of regions illustrated herein but is to be construed as including routine design choices and deviations in shapes that result, for example, from specific manufacturing techniques. For example, an implanted region that is schematically illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the disclosure.

Unless otherwise defined, all terms (including technical and scientific terms) used herein have the same ordinary meaning as commonly understood by one of ordinary skill in the art to which this disclosure most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

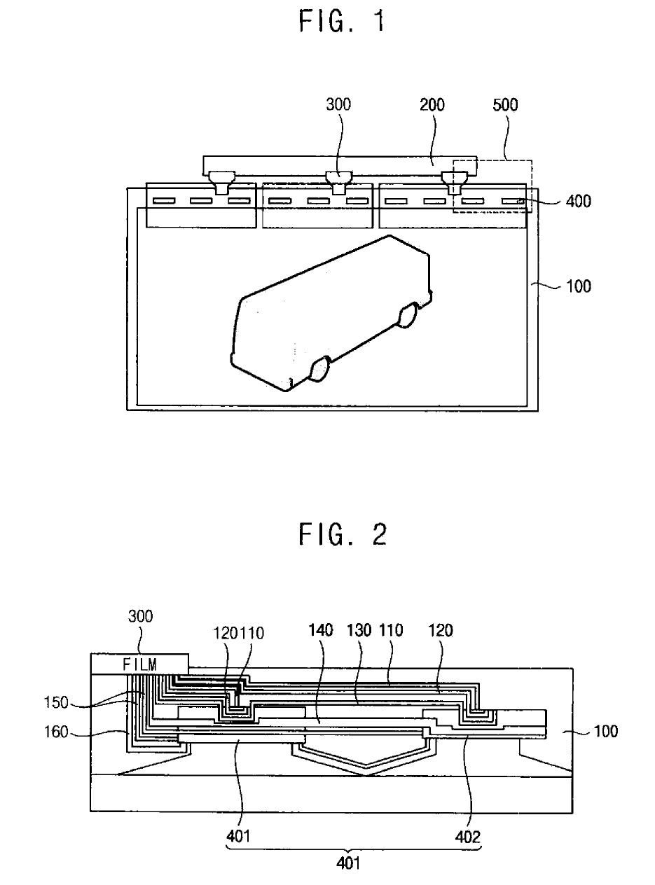

FIG. 1 is a plan view illustrating a display device according to an exemplary embodiment.

Referring to FIG. 1, a display device in accordance with the disclosure includes a first printed circuit board (PCB) 200, an LC cell 100 and a flexible second PCB (also referred to as a FPC) 300.

A timing controller (not shown) may be mounted on the PCB 300. The timing controller may generate control signals and driving signals, and transmits corresponding control signals and driving signals for driving the LC cell 100 via the flexible second PCB 300.

The current embodiment adopts three FPCs 300 and ten data drive ICs 400. Because each FPC 300 needs to be assigned with data ICs 400 equally and each FPC 300 needs to be a center portion among the assigned data ICs 400, fewer FPC 300s allows for a smaller PCB 200 to be possible. There are two reasons to reduce the number of FPCs 300 and to reduce the size of PCB 200. One is to reduce the cost to make an LCD; the other is to make a more compact display.

There are demerits to reducing the number of FPCs 300. Because the electric resistance of the wiring on the glass substrate is usually larger than the electric resistance of the wiring on the PCB 200, and because if the number of the FPC 300 is reduced the driving IC 400 should be electrically coupled to the timming controller by the wiring on the glass substrate, the quality of an image of the display is degraded.

There are two aspects that contribute to the degradation of image quality of a display. One is because when the electric resistance of the wirings is too large; the signals transmitted from the timing controller to the driver ICs 400 are distorted. The other is that as the electric resistance differences among wirings which connect the timing controller to ICs 400 gets larger; the signal distortion differences among the ICs becomes larger.

Though FIG. 1 shows an embodiment that adopts three FPCs, the number of FPCs 300 may be only one or two. And the explanation above can be applied similarly. In other embodiments of the invention, more than three FPCs are adopted, and the explanation above can also be applied similarly.

To improve the image quality of a display, we should reduce the electric resistance of the wiring on the substrate. FIG. 2 shows an embodiment of the present invention. The wire 10 which is labelled as VDD2 is coupled directly to FPC 300. VDD2 indicates an analog voltage source which provides a gray volgate to the pixels of the display. The wire 120 which is labelled as VSS2 is also directly coupled to FPC 300. VSS2 also indicates another analog voltage source which provides a common voltage to the pixels of the display. The distortion of the analog signals is more critical to the display image quality than the distortion of the digital signals because the digital signals have a bigger margin than analog signals which means that all digital signals that belong to a certain range of level are considered to have the same value.

Referring to the source drive IC 402, the wirings 130, 140, 150 and 160 are coupled to FPC 300 through the drive IC 401. The wiring may pass by the IC 401. The wiring may pass both ways that is to say through the IC 401 and pass by the IC 401. The key is to reduce the area of the wirings. FIG. 6 may be an example of this structure. The metal pads 180 are coupled through another metal layer 190. The metal layer 190 may be formed with the same layer to the metal pad 180. The metal pads 180 are also electrically coupled through the driver IC 400. The bumps 408 and 409 are made of a conductive material. The bumps 408 and 409 are electrically coupled through the driver IC 400 with a conductive wire (not shown). The bumps 408 and 409 are electrically coupled to the metal pad 180 by conductive balls 403. The conductive balls 403 may have some other shape. The ICs 400 and the wirings of FIG. 2 are positioned on the pheripheral area of the LC cell 100. Because the pheripheral area of the LC cell 100 needs to be as small as possible, the pheripheral area should be used efficiently.

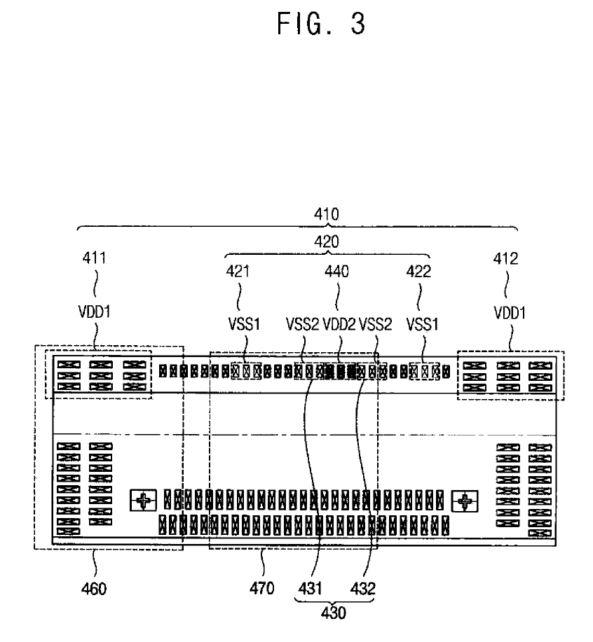

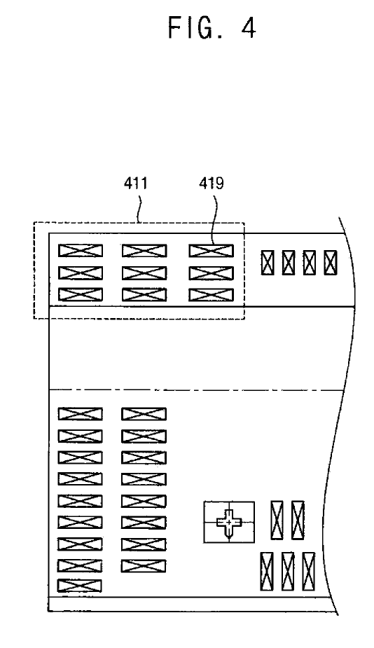

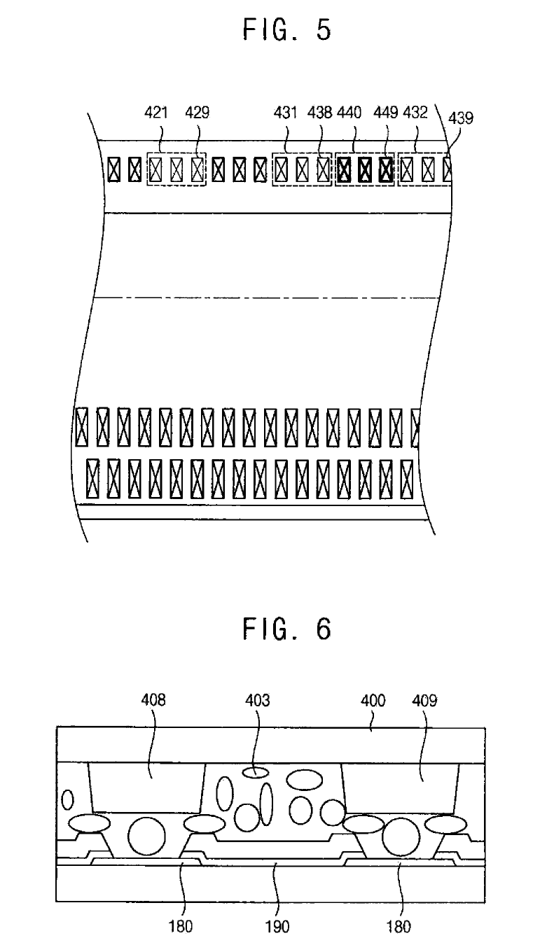

Referring to FIGS. 3 through 5, FIG. 3 shows the bottom of the source IC 400 whose portions are exaggerated in FIG. 4 and FIG. 5. It shows many bumps 411, 419, 421, 429 and so on. The bumps are terminals which are connected to the wirings inside the source drive IC 400. To reduce the contact resistance, a plurality of VDD1 bumps 411 is designed. VDD1 indicates a digital voltage source which is applied to a logic circuit as a high voltage. Similarly, VSS1, VSS2, and VDD2 are designed with a plurality of bumps. VSS1 indicates a digital voltage source which is applied to a logic circuit as a low voltage.

FIG. 6 shows a cross-sectional view of the area where a source IC 400 exists. The two bumps 408 and 409 may be two of the bumps of VDD1 411 which is intended to reduce electric contact resistance. The bumps 408 and 409 are electrically coupled to each other through the driver IC 400 with a conductive wire (not shown). The bump 408 may be the bump 419 and the bump 409 may be one of the bumps of VDD1 412 as explained above. This structure is intended to reduce the electric resistance of the wiring between the metal pads 180.

As shown in FIG. 2, referring to the IC 402 which is at an end of the wirings 140 and 130, the structure having multi bumbs and two way wirings is the same as the explanation above, which helps to reduce electric resistance. Even in the wirings VDD2 and VSS2 have multi bumps and two way wirings.

Another embodiment of the invention is shown in FIG. 2. The shape of some part of the wirings under the ICs 401 and 402 is narrower than the wiring that does not overlap with the ICs 401 and 402. This area itself does not have enough space to increase the width of the wiring because a plurality of conductive wires should pass by this area. This is why the other portion of the wirings is wider than the portion of wirings overlapping with the ICs 401 and 402. The wider wiring has a lower electric resistance. So one embodiment of the invention includes widening a portion of wiring which couples ICs more than a portion of wiring that overlaps with one of the ICs.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The embodiments above were described mainly about LCD devices. All of the embodiments above are possibly applicable to OLED, PDP, or other displays.

What is claimed is:

1. A display device comprising:
a first source IC which is electrically coupled to a control board through a first digital power circuit and a first analog power circuit;
a second source IC which is electrically coupled to the first source IC through a second digital power circuit; and
a second analog power circuit which couples the second source IC to the control board,
wherein the second analog power circuit is not coupled directly to the first source power source IC.

2. The display device of claim 1, wherein the first and second analog power circuits transmit the source voltage of a gray scale.

3. The display device of claim 1, wherein the first and second analog power circuits transmit the source voltage of a common voltage.

4. The display device of claim 1, wherein the first and second digital power circuit transmits the source voltages of a logic circuit.

5. The display device of claim 4, wherein the source voltages of a logic circuit are a gate-on voltage or gate-off voltage.

6. The display device of claim 1, wherein the first and second source ICs are mounted on a glass substrate.

7. A display device comprising:
a first IC mounted on a glass substrate;
a first group of bumps and a second group of bumps formed on the first IC,
wherein the first group of bumps and the second group of bumps contact the glass substrate,
the bumps of the first group are separated within a first distance of each other;
the bumps of the first group are separated from the bumps of the second within a second distance;
the first distance is smaller than the second distance;
the bumps of the first group are electrically coupled to each other through the IC with conductive material and through a first wire on the glass substrate; and
the first group of bumps are elecally coupled to the second group of bumps through the first IC with conductive material and through a second wire on the glass substrate.

8. The display device of claim 7, wherein the first group of bumps is positioned substantially at the opposite on the first IC with respect to the position of the second group of bumps in the longitudinal direction.

9. The display device of claim 8, further comprising:
a third wire formed on the glass substrate, being electrically coupled to the first wire and the second wire, and extending to an edge portion of the glass substrated to couple to a forth wire outside the glass substrate.

10. The display device of claim 9, wherein at least a portion the first wire and the second wire is substantially narrower than most part of the third wire.

11. The display device of claim 9, further comprising:
a second IC formed on the glass substrate and electrically coupled to the third wire;
wherein the second IC is between the first IC and the edge portion which the third wire extends; and one end of the first wire is connected to the second wire and the other end of the first wire terminages.

12. The display device of claim 11, wherein the end of the first wire overlaps with the first IC.

13. The display device of claim 11, wherein the end of the first wire extends outside the overlapping area with the first IC.
